(19) United States
(12) Patent Application Publication
(10) Pub. No.: US 2014/0364529 A1
(43) Pub. Date: Dec. 11, 2014

(54) SEQUENTIAL/SIMULTANEOUS MULTI-METALIZED NANOCOMPOSITES (S2M2N)

(71) Applicant: U.S.A. as represented by the Administrator of the National Aeronautics and Space Administration, Washington, DC (US)

(72) Inventors: Cheol Park, Yorktown, VA (US); Jin Ho Kang, Newport News, VA (US); Godfrey Sauti, Hampton, VA (US); Luke J. Gibbons, Williamsburg, VA (US); Sharon E. Lowther, Hampton, VA (US); Robert G. Bryant, Williamsburg, VA (US)

(21) Appl. No.: 14/244,538

(22) Filed: Apr. 3, 2014

Related U.S. Application Data
(60) Provisional application No. 61/807,879, filed on Apr. 3, 2013.

(51) Int. Cl. C08J 9/40

(52) U.S. Cl. CPC C08J 9/40; C08J 2379/08
USPC 521/183

(57) ABSTRACT

Sequential and simultaneous methods of making a multi-metalized nanocomposite. A method includes providing a porous matrix, dissolving at least a first metal or metalloid precursor and a second metal or metalloid precursor in a supercritical carbon dioxide (CO₂) fluid, wherein the first and second metal or metalloid precursors are different, infusing the supercritical CO₂ fluid with the dissolved first and second metal or metalloid precursors into the porous matrix, lowering the pressure to trap the infused first and second metal or metalloid precursors in the porous matrix and reducing the first and second metal or metalloid precursors at an elevated temperature to form first and second metal or metalloid nanoparticles in the porous matrix.

### CROSS-REFERENCE TO RELATED PATENT APPLICATION(S)

This application claims the benefit of and priority to U.S. Provisional Application No. 61/807,879, filed on Apr. 3, 2013, the contents of which are hereby incorporated by reference in their entirety.

### STATEMENT REGARDING FEDERALLY SPONSORED RESEARCH OR DEVELOPMENT

The invention described herein was made in the performance of work under a NASA contract and by employees of the United States Government and is subject to the provisions of Public Law 96-517 (35 U.S.C. §202) and may be manufactured and used by or for the Government for governmental purposes without the payment of any royalties thereon or therefore. In accordance with 35 U.S.C. §202, the contractor elected not to retain title.

### BACKGROUND OF THE INVENTION

Well-dispersed metal decorated nanotube or nanowire polymer composites have rarely been reported because of the excessive weight contrast between the decorated tubes and the polymer matrix. However, various properties, such as high electrical conductivity, permittivity, permeability, wear resistance, anti-penetrant, radiation shielding and high toughness are desirable and can be achieved with metalized nanocomposites if well made. Further, it is desirable to have nanocomposites that exhibit improvement in more than one of these properties and thus be capable of performing multiple functions.

### BRIEF SUMMARY OF THE INVENTION

Embodiments of the invention are drawn to sequential and simultaneous methods of making multi-metalized nanocomposites. Other embodiments are drawn to multi-metalized nanocomposites made by the methods. Still other embodiments are drawn to devices made with the multi-metalized nanocomposites. Such devices include, but are not limited to, radiation shielding, electromagnetic interference shielding, lightning protection, catalysts, gas sensors, fuel cell catalysts, battery anodes, supercapacitors and a flexible light emitting diode displays.

An embodiment is drawn to a method of making a multi-metalized nanocomposite including providing a porous matrix, dissolving a first metal or metalloid precursor in a supercritical carbon dioxide (CO₂) fluid, infusing the supercritical CO₂ fluid with the dissolved first metal or metalloid precursor into the porous matrix, lowering the pressure to trap the infused first metal or metalloid precursor in the porous matrix, reducing the first metal or metalloid precursor at an elevated temperature to form first metal or metalloid nanoparticles in the porous matrix, dissolving at least a second metal or metalloid precursor in a supercritical carbon dioxide (CO₂) fluid after reducing the first metal or metalloid precursor, infusing the supercritical CO₂ fluid with the dissolved second metal or metalloid precursor into the porous matrix, lowering the pressure to trap the infused second metal or metalloid precursor in the porous matrix and reducing the second metal or metalloid precursor at an elevated temperature to form second metal or metalloid nanoparticles in the porous matrix Another embodiment is drawn to a method of making a multi-metalized nanocomposite that includes providing a porous matrix, dissolving at least a first metal or metalloid precursor and a second metal or metalloid precursor in a supercritical carbon dioxide (CO₂) fluid, wherein the first and second metal or metalloid precursors are different, infusing the supercritical CO₂ fluid with the dissolved first and second metal or metalloid precursors into the porous matrix, lowering the pressure to trap the infused first and second metal or metalloid precursors in the porous matrix and reducing the first and second metal or metalloid precursors at an elevated temperature to form first and second metal or metalloid nanoparticles in the porous matrix. In the above embodiments, the first and second metal or metalloid precursors can include Ag, Au, Cu, Fe, Pt, Ni, Pd, Co, Li, Gd, W, Al, B or any combination of one or more of the foregoing; and the first and second metal or metalloid precursors can be the same or different. In some embodiments, the first and second metal or metalloid precursors are different.

In another aspect of the invention, the above embodiments may further include dissolving at least a third metal or metalloid precursor in a supercritical carbon dioxide (CO₂) fluid, infusing the supercritical CO₂ fluid with the dissolved third metal or metalloid precursor into the porous matrix, then lowering the pressure to trap the infused third metal or metalloid precursor in the porous matrix and reducing the third metal or metalloid precursor at an elevated temperature to form third metal or metalloid nanoparticles in the porous matrix.

In some of these embodiments, the first, second, and third metal or metalloid precursors each independently comprise Ag, Au, Cu, Fe, Pt, Ni, Pd, Co, Li, Gd, W, Al, B, or any combination of one or more of the foregoing. In some embodiments, the third metal or metalloid precursor is different from the first and second metal or metalloid precursors.

Another embodiment is drawn to a multi-metalized nanocomposite comprising a porous matrix and at least two different types of metal or metalloid nanoparticles in the porous matrix.

### BRIEF DESCRIPTION OF THE SEVERAL VIEWS OF THE DRAWINGS

The accompanying drawings, which are incorporated herein and constitute part of this specification, illustrate exemplary embodiments of the invention, and together with the general description given above and the detailed description given below, serve to explain the features of the invention.

FIGS. 1(a)-1(f) are high resolution scanning electron microscope (HRSEM) micrographs of multi-metallized nanocomposites including Ag/1 wt % SWNT/β-CNAO prepared by (a) 20% and (b) 70% metallization solutions, and Ag/10 wt % SWNT/β-CNAO prepared by (d) 20% and (e) 70% metallization solutions after curing. (c), (f) 1 wt % and 10 wt % SWNT/β-CNAO/Ag samples prepared by 70% metallization solution before curing;

FIG. 2(a) is topograph and FIG. 2(b) is a tunneling AFM image of Ag/10 wt % SWNT/β-CNAO prepared by 20% metallization solution;

FIGS. 3(a)-3(h) are scanning tunneling electron microscope (STEM) micrographs of Ag/0.1 wt % SWNT/β-CNAO samples taken at specific locations from the surface without SWNT (a)-(d) and with SWNT (e)-(h);

FIG. 4 is a histogram illustrating the effects of metallization on the low frequency conductivity of Ag-MNPC samples containing 10% SWCNT;

FIGS. 5(a)-(b) are stress-strain curves of tensile tests for (a) 0.1% SWNT/b-CNAO composite (control), (b) Ag/0.1% SWNT/b-CNAO composite (Ag-MNPC);

FIGS. 6(a)-6(f) are HRSEM micrographs illustrating multi-metallized nanoparticle composites (MNPCs) with (a) Pt, (b) Ni, (c) Fe at 70% precursor solution with the 10% SWNT-polyimide composite at a low magnification and (d) Pt, (e) Ni, (f) Fe at 70% precursor solution with the 10% SWNT-polyimide composite at a high magnification;

FIG. 7 is a process flow diagram illustrating an embodiment method for forming a multi-metallized composite by sequential supercritical fluid metallization of a porous matrix; and

FIG. 8 is a process flow diagram illustrating an embodiment method for forming a multi-metallized composite by simultaneous supercritical fluid metallization of a porous matrix.

### DETAILED DESCRIPTION OF THE INVENTION

For purposes of description herein, it is to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The word “exemplary” is used herein to mean “serving as an example, instance, or illustration.” Any implementation described herein as “exemplary” is not necessarily to be construed as preferred or advantageous over other implementations.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The inventors have discovered that it is possible to fabricate nanocomposites that are capable of performing multiple functions by infusing a matrix material with a least two different nanomaterials, each of which improves a property of the matrix. That is, by making multi-metalized nanocomposites, it is possible to improve multiple properties of the matrix. The inventors have further discovered that a number of different matrix materials may be improved with the methods discussed in more detail below. Properties that may be improved include, optical response, electrical conductivity, permittivity, permeability, wear resistance, anti-penetrant, radiation shielding and toughness which are useful for many NASA missions and other conventional applications.

Embodiments of the present invention include sequential and simultaneous multi-metalized nanocomposites (S2M2N) and methods of making them. The multi-metalized nanocomposites of the present invention offer multiple functions via supercritical fluid (SCF) sequential or simultaneous multi-metal infusions into pre-made nanotube polymer composites or any porous structures, such as woven carbon fiber mats or foams.

Well-dispersed metal decorated nanotube or nanowire polymer composites have rarely been reported because of the excessive weight contrast between the decorated tubes and the polymer matrix. However, a porous matrix comprised of polymer composites, such as nanotube polymer composites, may be beneficial because the interface between the polymer and nanotube and free volume of the polymer itself may be very readily infused with the metal or metalloid precursor. The embodiments described in more detail below provide environmentally friendly methods to develop uniformly dispersed metalized nanocomposites. The S2M2N process offers diverse functionalities by adding multiple nanoparticles into nanoinclusions (nanotubes, nanowires, etc) in the matrix. Examples, include but are not limited to, Co/Ni and Pd/Ag/Au (EMI shielding), Pd, Au, Pt (electrical conductivity), B, W (wear resistance/anti-penetrant), and Li, B, Gd (radiation shielding).

In embodiments of the method, multiple metal precursors are infused sequentially or simultaneously into a solid single wall carbon nanotube (SWCNT), carbon nanotubes or boron nitride nanotube (BNNT), boron carbon nitride nantube polymer nanocomposites or porous carbon fiber or nanotube mats via a supercritical fluid (SCF) infusion method at a controlled pressure, temperature, and time condition. Any supercritical fluid may be used, such as CO₂. The supercritical fluid acts as the precursor carrier. No toxic solvents are required and no contaminants are generated.

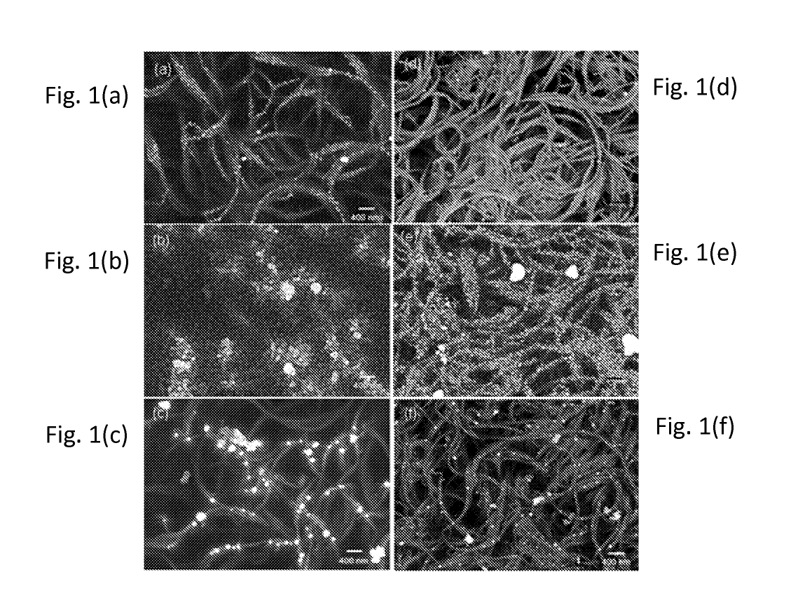

The infused metals can preferentially deposit on the nanotubes in the polymer matrix as illustrated in FIGS. 1(a)-1(f). FIGS. 1(a)-1(f) are high resolution scanning electron microscope (HRSEM) micrographs of multi-metallized nanocomposites including Ag/1 wt % SWNT/β-CNAO prepared by (a) 20% and (b) 70% metallization solutions, and Ag/10 wt % SWNT/β-CNAO prepared by (d) 20% and (e) 70% metallization solutions after curing. (c), (f) 1 wt % and 10 wt % SWNT/β-CNAO/Ag samples prepared by 70% metallization solution before curing. Some nano-elements, such as B and W, can be preferentially deposited on the surface of the composite to provide high wear resistance and anti-penetrant capability. The infusion process makes the composite tougher by increasing the free volume of the composite. Additionally, microwave and cavitational force (sonication) can be applied during the infusion step to modify the nanoparticle phase (cause reduction) and morphology. This may be accomplished, for example, with a modified SCF infusion instrument provided by Applied Separation Inc (ASI). The process may be used on film, powder, 3D complexes, and compacts in batch quantities.

Multiple nanometals (e.g. nanoparticles made of any combination of metals and/or metalloids including metals (such as silver (Ag), gold (Au), copper (Cu), iron (Fe), platinum (Pt), nickel (Ni), palladium (Pd), cobalt (Co), lithium (Li), gadolinium (Gd), tungsten (W), or aluminum (Al)) or metalloids (such as boron (B))) can be incorporated into nanocomposites to offer various functionalities without disrupting the already dispersed nanoinciusions (e.g. nanotubes, nanorods) and the matrix. The SCF process does not use organic solvents and does not produce contaminants, i.e., it is environmentally friendly. The nanoparticles can decorate pre-existing nanostructures (e.g. carbon nanotubes (CNT), boron nitride nanotubes (BNNT), glucan particles GPs) in a polymer matrix or nanowire surfaces preferentially as illustrated in FIG. 1, if the redox potential of the metal is greater than that of the pre-existing nanostructures. The proposed method is effective in incorporating multiple functional nanoparticles into any porous structure (e.g. foams, aerogels, buckypapers, engineering fabrics (woven/non-woven fibers), and textiles).

Carbon dioxide (CO₂) in its supercritical state has very low surface tension and the permeability to reach deeply into the smallest interstices to deposit metals deeper into the polymer substrate (from nm to mm depth) and porous structures then chemical vapor deposition (CVD) and physical vapor deposition (PVD) methods. Compared to other coating processes such as CVD and PVD, supercritical fluid deposition offers impregnation deeper into the polymer at relatively high deposition rates and can accommodate challenging topographies.

Future aerospace vehicles will preferably have structural airframe materials with tailorable properties to manage the weight, temperature, structural, radiation, and electromagnetic challenges associated with high-speed, high-altitude flights. By incorporating metallic nanoparticles on the percolated SWCNTs in a polymer matrix, the electrical conductivity can increase orders of magnitude to protect against lightning strike and electromagnetic interference (EMI). Woven and non-woven highly compact carbon fiber mats can be readily metalized by the SCF multi metal infusion method to improve transverse electrical conductivity before or after resin transfer molding. Any metal or inorganic precursors can be infused into nanostructure-polymer composites and porous structures to improve various functions for many NASA missions which include; wear resistance/anti-penetrants, radiation shielding, EMI shielding, lightning protection, catalysts, and gas sensing (using nanotubes to sense substances such as NO₂), fuel cell catalysts, battery anodes, gas sensing (Pd), supercapacitors, and flexible displays-organic LEDs (depositing quantum dots).

Devices that can be made, include but are not limited to, lightning protection for aerospace vehicles, EMI shielding for aerospace vehicles, automobiles, and cell phones, and electronic devices, flexible organic magnet materials, highly conductive flexible materials for electrodes and supercapacitors, conductive and reflective solar sail gossamer structures, large scale deployable antennas which can manage EM signals in space, gas separation and filters, catalysts embedded in flexible membranes and gas sensors.

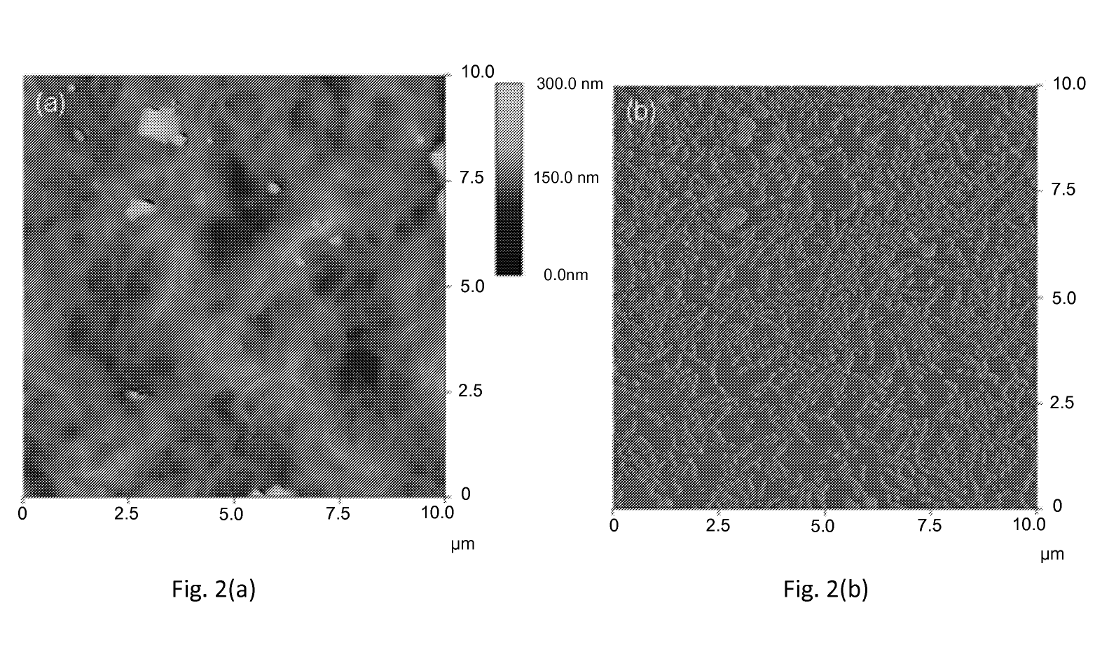

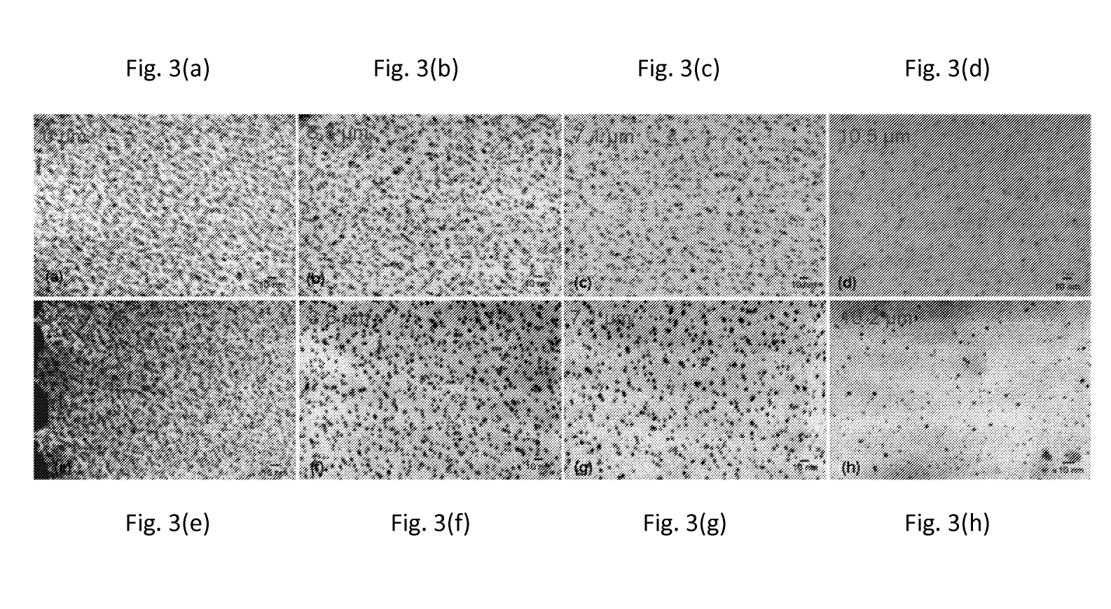

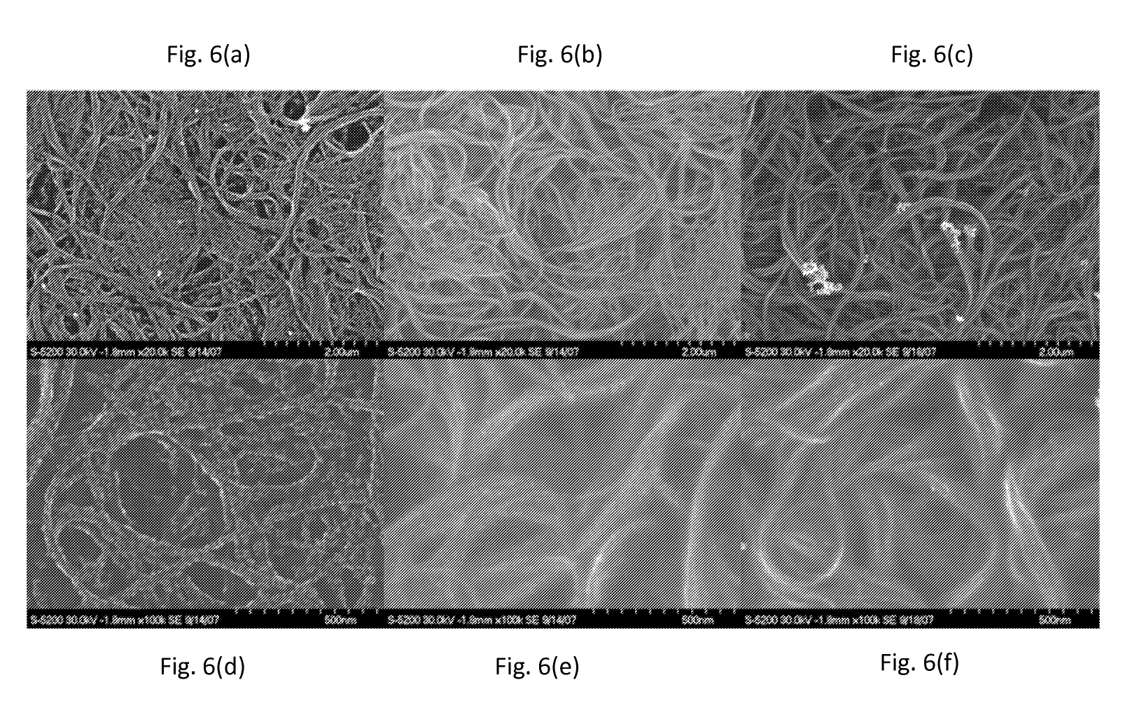

FIGS. 2(a)-2(b), 3(a)-3(h) and 6(a)-6(f) illustrate multi-metalized nanocomposites made according the methods described above. Specifically, FIG. 2(a) is a topograph and FIG. 2(b) is a tunneling AFM image of Ag/10 wt % SWNT/β-CNAO prepared by 20% metallization solution. FIGS. 3(a)-3(h) are scanning tunneling electron microscope (STEM) micrographs of Ag/0.1 wt % SWNT/β-CNAO samples taken at specific locations from the surface without SWNT (a)-(d) and with SWNT (e)-(h). The samples were prepared by the supercritical fluid method with 70% metallization solution and then microtomed to visualize the inside morphology. FIG. 6(a)-6(f) are HRSEM micrographs illustrating multi-metallized nanoparticle composites (MNPCs) with (a) Pt, (b) Ni, (c) Fe at 70% precursor solution with the 10% SWNT-polyimide composite at a low magnification and (d) Pt, (e) Ni, (f) Fe at 70% precursor solution with the 10% SWNT-polyimide composite at a high magnification.

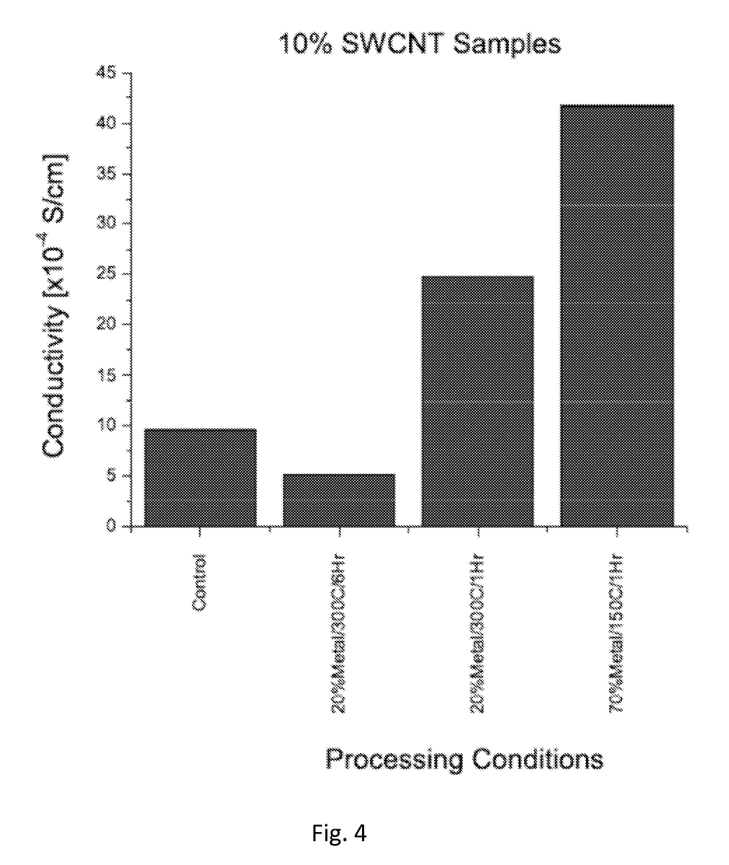

FIG. 4 is a histogram illustrating the effects of metallization on the low frequency conductivity of Ag-MNPC samples containing 10% SWCNT. As can be seen in FIG. 4, the addition of silver nanoparticles to form the Ag-metallized nanotube polymer composite may result in a greater than fourfold increase in the conductivity of matrix without Ag.

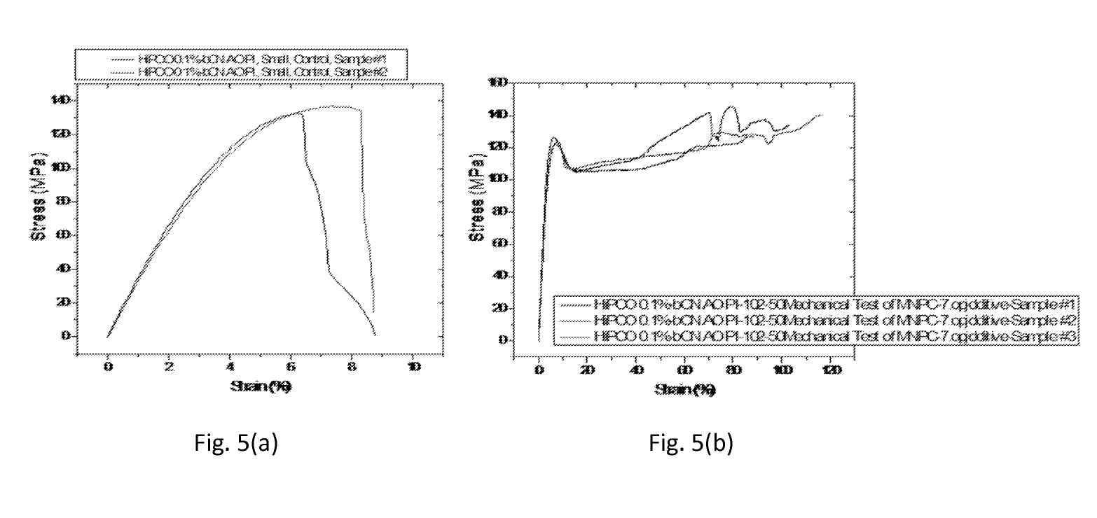

FIGS. 5(a)-(b) are stress-strain curves that illustrate the tensile properties of (a) 0.1% SWNT/b-CNAO composite (control) and (b) Ag/0.1% SWNT/b-CNAO composite (Ag-MNPC). The % elongation at break for Ag-MNPC increased more than an order of magnitude versus the non-metallized control SWNT composite.

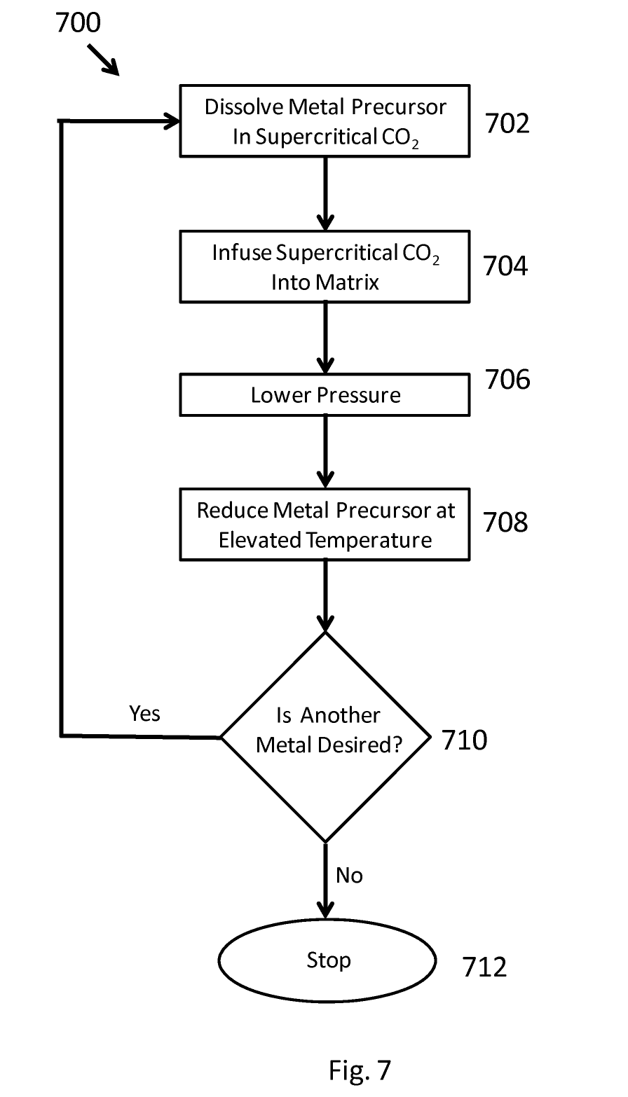

FIG. 7 is a process flow diagram illustrating an embodiment method 700 for forming a multi-metallized nanocomposite layer by sequential supercritical fluid metallization of a porous matrix. In step 702 a metal or metalloid precursors may be dissolved in a supercritical carbon dioxide (CO₂). In step 704 the supercritical CO₂ fluid with the precursor dissolved in it may be infused into a porous matrix. In step 706 the pressure may be lowered, thereby trapping the infused metal precursor into the internal pores and surfaces of the porous matrix uniformly while the highly diffusive CO₂ escapes rapidly. In step 708 the trapped and deposited metal precursor may be reduced at an elevated temperature to create nanoparticles. In step 710 a determination is made as to whether another, different metal or metalloid precursor should be added. This may be done, as discussed above, to improve another property not improved by the previously added metal precursor. If it is desired to add another precursor, the process is repeated. If it is not desirable to add another precursor, the process is ended.

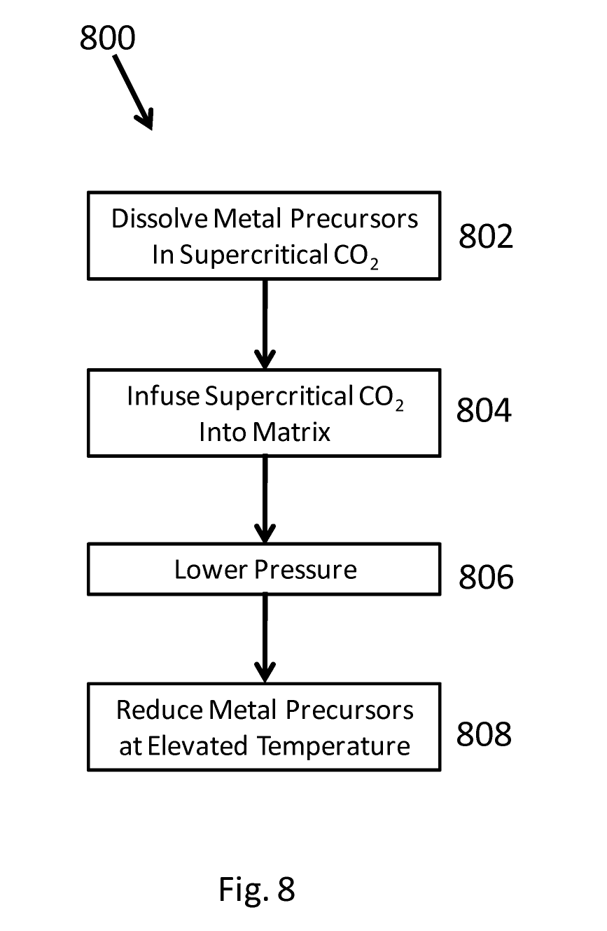

FIG. 8 is a process flow diagram illustrating an embodiment method 800 for forming a metallized nanocomposite by supercritical fluid metallization of a porous matrix. Method 800 is similar to method 700 described above with reference to FIG. 5, except that in method 800 all of the desired precursors are applied together. In step 802 the desired precursors may be dissolved in a supercritical carbon dioxide (CO₂) fluid. Similarly to the previous embodiment, in step 804 the supercritical CO₂ fluid with the precursors dissolved in it may be infused into a porous matrix. In step 806 the pressure may be lowered, thereby trapping the infused metal precursors into the internal pores and surfaces of the porous matrix uniformly while the highly diffusive CO₂ escapes rapidly. In step 808 the trapped and deposited metal precursors may be reduced at an elevated temperature to create a plurality of different nanoparticles.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein. Thus, it is to be understood that variations and modifications can be made on the aforementioned methods and structures without departing from the concepts of the present invention, and further it is to be understood that such concepts are intended to be covered by the following claims unless these claims by their language expressly state otherwise.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or,” As used herein, the term “and/or” includes any and all combinations of one or more of the associated listed items. As also used herein, the term “combinations thereof” includes combinations having at least one of the associated listed items, wherein the combination can further include additional, like non-listed items. Further, the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

Reference throughout the specification to “another embodiment”, “an embodiment”, “exemplary embodiments”, and so forth, means that a particular element (e.g., feature, structure, and/or characteristic) described in connection with the embodiment is included in at least one embodiment described herein, and can or cannot be present in other embodiments. In addition, it is to be understood that the described elements can be combined in any suitable manner in the various embodiments and are not limited to the specific combination in which they are discussed.

This written description uses examples to disclose the invention, including the best mode, and also to enable any person skilled in the art to make and use the invention. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of making a multi-rnetalized nanocomposite, comprising:
providing a porous matrix;
dissolving a first metal or metalloid precursor in a supercritical carbon dioxide (CO₂) fluid;
infusing the supercritical CO₂ fluid with the dissolved first metal or metalloid precursor into the porous matrix;
lowering the pressure to trap the infused first metal or metalloid precursor in the porous matrix;
reducing the first metal or metalloid precursor at an elevated temperature to form a plurality of first metal or metalloid nanoparticles in the porous matrix;
dissolving at least a second metal or metalloid precursor in a supercritical carbon dioxide (CO₂) fluid after reducing the first metal or metalloid precursor;
infusing the supercritical CO₂ fluid with the dissolved second metal or metalloid precursor into the porous matrix;
lowering the pressure to trap the infused second metal or metalloid precursor in the porous matrix; and
reducing the second metal or metalloid precursor at an elevated temperature to form a plurality of second metal or metalloid nanoparticles in the porous matrix.

2. The method of claim 1, wherein the first and second metal or metalloid precursors comprise Ag, Au, Cu, Fe, Pt, Ni, Pd, Co, Li, Gd, W, Al, B or any combination of one or more of the foregoing.

3. The method of claim 2, further comprising:
dissolving at least a third metal or metalloid precursor in a supercritical carbon dioxide (CO₂) fluid;
infusing the supercritical CO₂ fluid with the dissolved third metal or metalloid precursor into the porous matrix;
lowering the pressure to trap the infused third metal or metalloid precursor in the porous matrix; and
reducing the third metal or metalloid precursor at an elevated temperature to form third metal or metalloid nanoparticles in the porous matrix.

4. The method of claim 1, wherein the porous matrix comprises carbon nanotubes, boron nitride nanotubes, boron carbon nitride nanotubes, woven porous fiber or nanotube mats, unwoven porous fiber or nanotube mats, nanotube polymer nanocomposites, graphene-polypyrrole nanocomposites, aerogels, buckypapers, textiles, foams or polymer composites thereof.

5. The method of claim 1, further comprising sonicating the porous matrix during infusing the first metal or metalloid precursor and/or the second metal or metalloid precursor.

6. The method of claim 1, wherein the first metal or metalloid precursor and/or the second metal or metalloid precursor is preferentially deposited on one or more surfaces of the porous matrix.

7. A method of making a multi-metalized nanocomposite, comprising:
providing a porous matrix;
dissolving at least a first metal or metalloid precursor and a second metal or metalloid precursor in a supercritical carbon dioxide (CO₂) fluid, wherein the first and second metal or metalloid precursors are different;
infusing the supercritical CO₂ fluid with the dissolved first and second metal or metalloid precursors into the porous matrix;
lowering the pressure to trap the infused first and second metal or metalloid precursors in the porous matrix; and
reducing the first and second metal or metalloid precursors at an elevated temperature to form first and second metal or metalloid nanoparticles in the porous matrix.

8. The method of claim 7, wherein the first and second metal or metalloid precursors comprise Ag, Au, Cu, Fe, Pt, Ni, Pd, Co, Li, Gd, W, Al, B or any combination of one or more of the foregoing.

9. The method of claim 7, further comprising dissolving at least a third metal or metalloid precursor in the supercritical carbon dioxide (CO₂) fluid when dissolving the first and second metal or metalloid precursors, wherein the third metal or metalloid precursor is different from the first and second metal or metalloid precursors.

10. The method of claim 1, wherein the porous matrix comprises carbon nanotubes, boron nitride nanotubes, boron carbon nitride nanotubes, woven porous fiber or nanotube mats, unwoven porous fiber or nanotube mats, nanotube polymer nanocomposites, graphene-polypyrrole nanocomposites, aerogels, buckypapers, textiles, foams or polymer composites thereof.

11. The method of claim 7, further comprising sonicating the porous matrix during infusing the first and second metal or metalloid precursors.

12. The method of claim 7, wherein the first and second metal or metalloid precursors are preferentially deposited on one or more surfaces of the porous matrix.

13. A multi-metalized nanocomposite comprising a porous matrix and at least two different types of metal or metalloid nanoparticles in the porous matrix.

14. The multi-metalized nanocomposite of claim 13, wherein the nanocomposite has one or more improved properties over the porous matrix selected from electromagnetic interference shielding, optical response, electrical conductivity, wear resistance, anti-penetrant or radiation shielding.

15. A device comprising the multi-metalized nanocomposite of claim 13, wherein the device comprises a radiation shielding, an electromagnetic interference shielding, a lightning protection, a catalysts, a gas sensor, a fuel cell catalyst, a battery anode, a supercapacitor or a flexible light emitting diode display.
